(19) United States
(12) Patent Application Publication
(10) Pub. No.: US 2010/0294995 A1
(43) Pub. Date: Nov. 25, 2010

(54) REFLECTOR GRAPHITE CONSISTING OF ISOTROPIC HIGHLY CRYSTALLINE NATURAL GRAPHITE AS THE MAIN COMPONENT AND SILICON OR ZIRCONIUM CARBIDE, AND PRODUCTION THEREOF

(75) Inventors: Milan Hrovat, Rodenbach (DE); Karl-Heinz Grosse, Gruendau (DE); Richard Seemann, Hanau (DE)

Correspondence Address: DICKSTEIN SHAPIRO LLP, 1633 Broadway, NEW YORK, NY, 10019, US

(73) Assignee: ALD Vacuum Technologies GmbH, Hanau (DE)

(21) Appl. No.: 12/743,685

(22) PCT Filed: Nov. 19, 2008
(86) PCT No.: PCT/EP08/65858

§ 371 Date: Jul. 21, 2010

(30) Foreign Application Priority Data
Nov. 20, 2007 (DE) 10 2007 056 135.2

(51) Int. Cl. G21F 1/00; B29C 43/00

(52) U.S. Cl. 252/478; 264/319

(57) ABSTRACT

Disclosed is reflector graphic which is characterized in that the main component of the graphite is nuclear-purity natural graphite in addition to silicon carbide and/or zirconium carbide, the pressed pieces are shaped by a combined cold-hot pressing process, and the thermal treatment of the pressed pieces is limited to temperatures of less than 2000° C.

The designation ‘reactor graphite’ emerged in the end of the year 1942, when the first nuclear fission in a graphite-moderated nuclear reactor has been conducted. The main reason for the importance of graphite in nuclear technology are its favorable nuclear-physical properties. To these belong its low capture cross-section, relatively low mass number and good moderator and reflector effect.

For designing and building of gas-cooled nuclear reactors, in particular the Mk II Advanced Gascooled Reactors, AGR, and helium-cooled high temperature reactors, HTGR, nuclear-purity graphite has become one of the most important reactor materials. Reactor graphite is used for both, for the production of fuel elements and also for fixed installations. An important example of the fixed installations is the reflector. The purpose of the reflector is to avoid a loss of neutrons by migration out of the reactor core. For that the reactor core is enclosed in a ceiling, side and bottom reflector consisting of graphite. The reactor graphite used for building the reflector is called reflector graphite.

The reflector graphite has to fulfil the following requirements:
The graphite has to be nuclear-pure.
This means, the capture cross-section for thermal neutrons should be lower than 4 mbarn;
High geometric density;
Good mechanical strength properties;
Low modulus of elasticity;
Low thermal expansion;
Good thermal conductivity;
High corrosion resistance against water vapor and air;
High stability in the case of irradiation with fast neutrons.

The graphite is subjected to high fluence of fast neutrons during the operation of the reactor. The neutrons may damage the graphite lattice. The reactor graphite must have a radiation resistance which fulfils the design criteria of the reactor, because the physical, mechanical and chemical properties of the graphite may be negatively affected by radiation induced damages.

This requirement for the reflector graphite is important, because its service life should be at least 30 years. During this time the reflector graphite is subjected to a very high integral fluence of fast neutrons of about 3×10²² n/cm² E>0.1 MeV.

According to literature of prior art it is clear that the graphite in the case of irradiation with fast neutrons, a temperature of above 1000° C. and a high dose of neutrons can only preserve its required dimensional stability and mechanical integrity, when the polycrystalline molded graphite articles have a high degree of graphitization and an isotropic orientation order of the single graphite crystals being present in a composite arrangement.

The irradiation behavior and the corresponding results are inter alia described in:

### GA-Report (March 1970)

Engel, G. B.: “Irradiation Behaviour of Nuclear Graphites at Elevated Temperatures” and BNWL-1056 Report Pacific Northwest-Laboratory Richland, Wash. (1969) of Helm, J. W.

Till today, reactor graphite for the production of reflector parts has only been produced of synthetic electrographite.

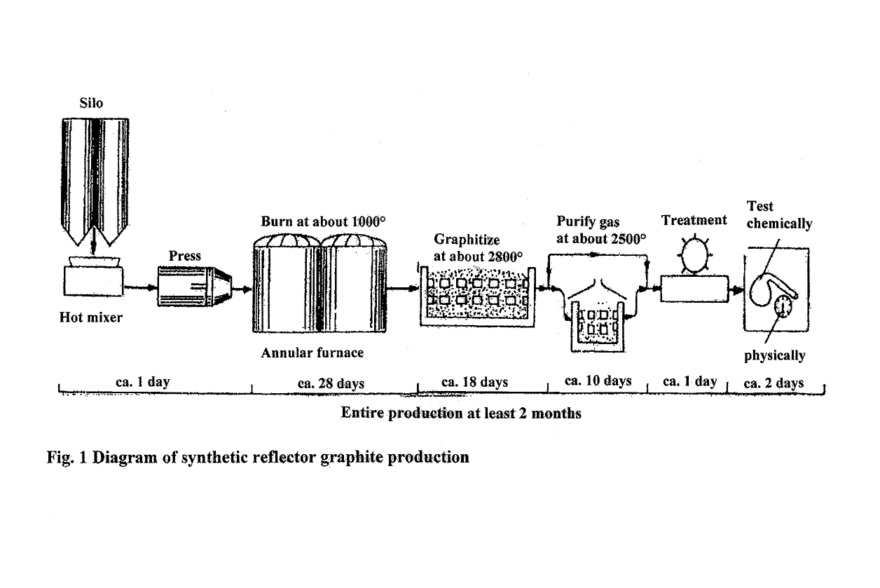

FIG. 1 shows the diagram of reactor graphite production.

Polycrystalline molded graphite articles consist of pure elemental carbon. The prerequisites of raw materials for the production of graphite are purity and graphitizability.

Petroleum and pitch cokes resulting from coking of crude oil residues and coal tar pitch fulfil these requirements. Tars or pitch are preferably used as liquid carbonaceous binders. The production of electrographite is conducted in several steps.

In FIG. 1 the production steps and the time course thereof are shown in diagram form.

At first, the calcined petroleum and pitch cokes are ground, screened and homogenized after mixing with the liquid tar or pitch binder by hot kneading and subsequently they are processed into molded green compact articles by a strand or die pressing process. The amount of binder is relatively high and is ca. 30% by weight. In a subsequent burning process with the exclusion of air in a gas or oil heated annular furnace a solid product, the so-called hard-fired coal, is produced by coking of the binder. The molded green compact coal articles are surrounded with coke powder in the annular furnace to protect them from burn-up. After the coking process the molded coal articles are subjected to a thermal treatment at a temperature of up to 3100° C.

This process is conducted in large resistance-heated graphite furnaces in which the feed material with a surrounding layer of coke grit is used as a heating resistor.

Graphitization is conducted in elongated furnaces with a length of up to 30 m by short circuit. The current demand of such furnaces is up to 80.000 amperes. The graphite crystals built during coking in the petroleum or pitch coke having a diameter of about 0.5 nm (primary pyrolysis) grow to crystals of about 60 nm during this graphitization process. The coke bridges built during the coking of the binder are called secondary pyrolysis. Graphitization is a physical process of crystallization. The degree of graphitization mainly depends on the temperature, the graphitizability of the coke and the ratio of the primarily built coke to the secondarily built coke.

The measurements show that with the optimization of these parameters the degree of graphitization of the primary and secondary cokes increases with increasing temperature, but does not achieve the degree of graphitization of natural graphite.

The production method of the synthetic reactor graphite is described in the publication of
H. Nickel: Reaktorchemische Probleme, Teil II, Nuclear Research Facility Jülich, Institute for Reactor Materials (1968).

For reactor graphite, in particular for the reflector of high temperature nuclear reactors (HTR) of the succeeding generations, in addition an increased corrosion resistance against oxygen respectively water vapor is necessary. In the hypothetic case of an accident, such as e.g. a complete failure of the cooling facility and/or an uncontrolled penetration of air, water or water vapor into the reactor core, the graphite reflector should still stay in an operable condition.

An object of the present invention is the development of a reactor graphite and its production for gas-cooled nuclear reactors, in particular for high temperature reactors, which is suitable for the production of fixed installations, in particular of reflector parts, and which guarantees a life-long operation time of the reactor without a replacement of it.

The object is solved according to the present invention by the measures that the reactor graphite is nuclear-purity reactor graphite and that the main component consists of nuclear-purity natural graphite as well as silicon carbide and/or zirconium carbide, wherein the carbide is formed in situ by heating of binder coke or carbon black with SiO₂ and/or ZrO₂. The secondary coke built by coking of the binder is converted into the above-mentioned carbides by finally glowing in vacuum at a temperature of lower than 2000° C. Preferably, the present invention relates to reflector graphite.

In the sense of the present invention, main component means that the reactor graphite essentially consists of those components which form its main component. “Essentially consists of” means in this case that no additives were added to the graphite which are still present in the graphite after the processing according to the present invention. Nevertheless, the graphite according to the present invention may contain normal impurities. Impurities are substances which are present in the used materials, but which have not been added to them for achieving a certain purpose.

The invention for the production of reactor graphite is based on the following starting components:
Finely ground nuclear-purity natural graphite powder having high crystallinity
Petroleum coke graphitized in powder form above a temperature of 3000° C. (instead of graphitized petroleum coke also carbon black may be used)
Phenolformaldehyde binder resin
Powder of SiO₂ or ZrO₂ and the pressing auxiliary agents stearic acid and octanol.

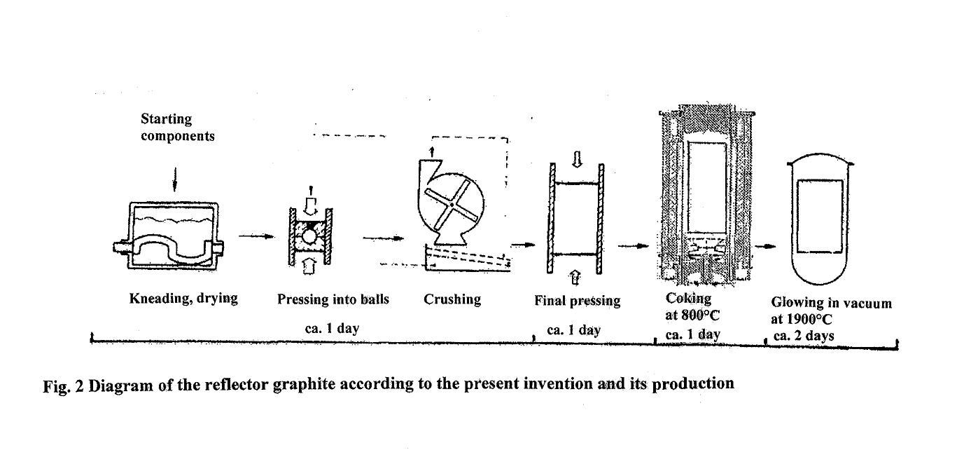

In FIG. 2 the process steps are shown in diagram form.

Preferably, the method is a method for the production of reflector graphite. The press powder is produced by kneading at room temperature with binder resin which has been solved in methanol and subsequently drying and grinding.

The pressing process is conducted in two steps according to the present invention:

In the first step, the balls are pressed in rubber molds at room temperature nearly in an isostatic condition and at a relatively high pressure of more than 100 MPa. Subsequently, the balls are crushed which produces a granulate having a mean diameter of about 1 mm. The granulate grain having defined porosity consists of about 1 million primary graphite particles having an isotropic steric arrangement.

In a second step, the isotropic granulate is finally pressed into graphite compacts in the malleable temperature range of the binder resin at a relatively low pressure of about 12 MPa. For improving the moldability in the granulate grain a lubricant and air displacement agent are incorporated. Stearic acid has shown to be most suitable as a lubricant.

For the final pressing of the graphite compacts, the air contained in the granulate feedstock was of great disadvantage. During the pressing process an important part thereof is forced into the center of the pressed piece and is finally incorporated there by pressing. The elastic recovery of this compressed air results in a weakening of the structure of the pressed piece during coking.

After coking the graphite compacts show property gradients in the direction to the center in connection with crack formation. For avoiding this, according to the present invention into the granulate grain a hydrocarbon compound is incorporated, the vapor pressure of which increases from very low values at room temperature to about 1000 hPa at pressing temperature and which becomes liquid during the pressing process. In this way the air present in the steel cavity is displaced during heating by the formation of vapor and the pressure load of the graphite compact is substantially reduced during the thermal treatment. Here, octanol as a displacement agent has shown the best results.

The heating to pressing temperature is conducted with a steel cavity fitted with a thermal oil heater. The heating facility consists of a temperature apparatus for heating and cooling. The apparatus supplies two heating circuits for the bottom plate and the cavity. During heating the cavity is covered with an insulating cap.

After heating to pressing temperature the insulating cap is removed and the cavity with the material being compressed is placed in the press. The pressing process is conducted between two molding plugs which can be moved independently from each other. During the compaction the press allows that under load the pressed piece is moved up and down relative to the cavity. Under these conditions the pressed piece achieves a nearly theoretically possible saturation density so that the gradient of density over the whole length of the pressed piece is negligibly low.

After cooling the cavity is transferred into the ejection facility and the pressed piece is ejected in a dimensionally stable condition at a temperature at which the binder resin solidifies, but the lubricant is still liquid.

For coking of the phenolformaldehyde binder resin the green graphite compacts are heated to ca. 800° C. in a recirculating furnace in an inert gas atmosphere, preferably in argon. The recirculating furnace is a cylindrical cap furnace. A fuel gas fan from which the rotational speed can be controlled sucks the protective gas argon top-down and blows it to the top again between the guide tube and the heated furnace jacket. The cracked products formed during the coking process will condense in the lower furnace area and will be removed from the coking process directly after their production. The heating and cooling cycle is very short in comparison to known methods and comprises 24 hours.

Finally, the coked molded graphite articles are glowed in vacuum (P<10⁻² mbar) at ca. 1900° C. in a graphite resistance-heated furnace.

According to the present invention, for glowing in vacuum the high chemical affinity of binder coke or of carbon black is used. The high affinity is primarily due to the nearly amorphous structure of both components. Thus, they selectively react with SiO₂ or ZrO₂ which were mixed during the production of the press powder into silicon carbide (SiC) or zirconium carbide (ZrC). Both carbides, SiC and ZrC, are tested reactor materials having cubic crystalline order (syngony) and thus they are inherently isotropic. SiC and ZrC are characterized by high hardness, high mechanic strength and a very good corrosion resistance. In this way the properties of the reactor graphite, such as for example density, breaking load, corrosion resistance and in particular high stability in the case of irradiation with fast neutrons, are significantly improved.

The following examples should explain the invention of the reactor graphite and its production in more detail without limiting the invention therewith.

### EXAMPLE 1

Use of natural graphite, graphitized petroleum coke, SiO₂ as well as the pressing auxiliary agents stearic acid and octanol.

For the production of press powder a natural graphite powder was mixed in advance with a petroleum coke powder which has been graphitized at 3100° C. in a weight ratio of 4:1 in a dry condition. With respect to the graphite components, 20% by weight of the phenolformaldehyde binder resin solved in methanol and the SiO₂ suspension were added. The content of the SiO₂ powder present as a suspension was 83.4% by weight, with respect to the binder resin. The homogenization was conducted in a kneader at room temperature. The material being kneaded was dried at a temperature of 105° C. and then ground. Subsequently, the press powder was mixed with 1% by weight of stearic acid (lubricant) and 0.16% by weight of octanol (air displacement agent). For the production of a homogenous mixture the stearic acid was melt, octanol was added and a part of the used press powder (ca. 10% by weight) was stirred into the mixture and then it was allowed to cool. The grindable material was mixed into the residual powder in a dry condition after comminution to a grain size of <1 mm.

The starting components had the following properties:
natural graphite with the name FP of the company Kropfmühl:
   bulk density 0.4 g/cm³,
   grain density 2.26 g/cm³,
   BET surface 2 m²/g,
   crystallite size Lc=100 nm,
   mean grain diameter 10 to 20 μm,
   ash content 200 ppm and
   equivalent of boron from the impurities of the ash <1 ppm.
graphitized petroleum coke with the name KRB <0.1 mm of the company Ringsdorff:
   graphitization temperature 3000° C.
   bulk density 0.65 g/cm³
   grain density 2.2 g/cm³
   BET surface 1.2 m²/g
   crystallite size Lc=60 nm
   mean grain diameter 30 to 40 μm
   ash content 10 ppm and
   equivalent of boron from the impurities of the ash <1 ppm
phenolformaldehyde resin of the type Novolak with the name 4911 of the company Bakelitte
   condensation agent HCl
   molecular weight 690
   softening temperature 101° C.
   pH value=6
   acid number=7.5
   free phenol 0.12% by weight
   coke yield 50%
   solubility in methanol 99.97% by weight
   ash content 160 ppm
   and equivalent of boron from the impurities of the ash 1 ppm. For increasing of the molecular weight after the condensation the resin was subjected to steam distillation.
SiO₂ powder, finely ground commercially available powder of SiO₂ having a mean grain diameter of 1 to 5 μm and a purity of 99.95%.

The press powder was filled into rubber molds of silicone rubber and was pressed to balls having a diameter of ca. 62 mm in a semiisostatic condition in the steel die at 100 MPa. For the intake of the press powder the rubber mold has an ellipsoid excavation.

In the case of an axial ratio of 1:1.7 the volume of the ellipsoid excavation was 550 cm³. The balls were crushed and for further processing a sieve fraction of between 0.314 and 3.14 mm of the granulate was used.

For the production of cylinders having a diameter of 300 mm and a height of 600 mm a steel cavity fitted with a thermal oil heater was filled with granulate in layers and the material being compressed was heated to 180° C. The pressing process was conducted between two molding plugs which can be moved independently from each other at a pressing pressure of 12 MPa. Thus it was possible to move the pressed piece under press load in the cavity up and down. Under these conditions the pressed piece yielded in a nearly theoretical saturation density of 1.95 g/cm³ and thus it was free of density gradients over the whole length. For coking of the binder, the pressed pieces were heated in an argon flow to 800° C. for 18 hours and finally glowed in vacuum (P<10⁻² mbar) at 1950° C. During this process the secondary coke formed from phenolformaldehyde resin reacted with SiO₂ to SiC according to the present invention.

### EXAMPLE 2

All production steps in powder form at 3000° C. as described in example 1 were unchanged, except the replacement of the SiO₂ powder by the ZrO₂ powder and of the graphitized petroleum coke by the lampblack. In this case, 16% by weight of petroleum coke were replaced by only 4% by weight of carbon black. The used ZrO₂ powder with the name TZ of the company ToyoSoda had a mean grain diameter of about 1 μm and a purity of 99.99%. The lampblack had a mean particle size of about 0.1 μm, a crystallite size Lc of 0.2 nm, an ash content of 110 ppm and an equivalent of boron from the impurities of the ash of lower than 1 ppm.

After the thermal treatment from the molded graphite articles test samples were taken and investigated for the following properties:
geometric density
compressive strength
tensile strength
modulus of elasticity, dynamic
specific electrical resistivity
linear thermal expansion
factor of anisotropy of linear thermal expansion and
corrosion resistance.

The results are listed in the following table:

| | Natural graphite | Natural graphite |
|---|---|---|
| | graphitized petroleum | carbon black |
| Graphite composition | coke SiC | ZrC |
| density (g/cm³) | 1.77 | 1.88 |
| compressive strength (MPa) | | |
| axial | 48.3 | 51.7 |
| radial | 49.8 | 53.2 |
| tensile strength (MPa) | | |
| axial | 10.6 | 11.8 |
| radial | 11.8 | 12.7 |
| modulus of elasticity, | | |
| dynamic (MPax 10³) | | |
| axial | 10.1 | 11.9 |
| radial | 11.7 | 12.3 |
| linear thermal expansion | | |
| (20-1000° C. 10⁻⁶/K) | | |
| axial | 3.8 | 3.7 |
| radial | 4.5 | 4.6 |
| factor of anisotropy of | 1.2 | 1.2 |
| linear thermal expansion | | |
| corrosion resistance at | 0.45 | 0.38 |
| 1000° C. and 1% by volume | | |
| of H₂O vapor (mg/cm² hour) | | |
| absorption cross section for | 4.2 | 3.9 |
| thermal neutrons (mbarn) | | |

From the table can be seen that the reactor graphite which has been developed according to the present invention is characterized by high density, good properties of strength and conductivity, in particular good isotropy of thermal expansion, high corrosion resistance and low absorption cross section for thermal neutrons.

Since during the production of the graphite press powder the single graphite grains are uniformly coated with a layer of binder resin which is solved in methanol, in the subsequent step of coking of the resin the formation of microcracks is promoted.

The formed microcracks, a high degree of graphitization of the main starting component natural graphite and an isotropic steric arrangement of the graphite crystals are the prerequisites that a high radiation resistance of the graphite with high fluences of fast neutrons above the required temperature is guaranteed.

For the production of synthetic electrographite a very long time period of ca. 2 months is necessary. The time needed for the reactor graphite according to the present invention is about 1 week which is nearly one tenth of the former time period (see FIG. 1 and FIG. 2).

During the burning process (coking of the binder) the surrounding of the pressed pieces with coke powder is not necessary. Since as the starting component graphite powders having a degree of graphitization which is as high as possible are used, the process of graphitization which would cause high energy costs is not necessary.

In addition, the secondary coke formed from binder is converted into chemical carbides of SiC and/or ZrC during the production of graphite without additional effort.

Through the above-mentioned features of the method according to the present invention it is possible to produce reactor graphite in a more economical way in relation to the methods known up to now.

1. Reflector graphite, characterized in that the main component of the graphite is nuclear-purity natural graphite and at least one of silicon carbide and zirconium carbide.

2. Reflector graphite according to claim 1, characterized in that the proportion of the natural graphite is higher than 50% by weight.

3. Reflector graphite according to claim 1, characterized in that the proportion of silicon carbide is in a range of 6 to 14% by weight.

4. Reflector graphite according to claim 3, characterized in that the content of silicon carbide is in a range of 6 to 14% by weight.

5. Reflector graphite according to claim 1, characterized in that the content of zirconium carbide is 10 to 30% by weigh.

6. Reflector graphite according to claim 5, characterized in that the content of zirconium carbide is 20 to 25% by weight.

7. A method of making reflector graphite according to claim 1, characterized in that a combination of nuclear-purity graphite powder, graphitized petroleum coke or carbon black, binder, and at least one of the silicon and zirconium oxide is compacted.

8. A method according to claim 7, characterized in that the oxides are suspended in a methanol-phenolformaldehyde resin binder solution and that the suspension is homogenized with graphite powder components by kneading at room temperature.

9. A method according to claim 8, characterized in that the homogenized composition is pressed at least 100 MPa isotropically in rubber molds into balls, the balls are crushed into a granulate having more than 1 million graphite particles which are arranged in an isotropic manner and said granulate is pressed into a molded graphite article in a subsequent hot pressing process.

10. A method according to claim 9, characterized in that grain a lubricant and air displacement agent are incorporated in the granulate.

11. A method according to claim 10, characterized in that stearic acid is used as a lubricant.

12. A method according to claim 11, characterized in that the content of stearic acid is up to 5% by weight.

13. A method according to claim 10, characterized in that a hydrocarbon compound is incorporated as the air displacement agent, the vapor pressure of which increases from room temperature to the pressing temperature and which becomes liquid during the pressing process.

14. A method according to claim 13, characterized in that octanol is used as the hydrocarbon compound.

15. A method according to claim 11, characterized in that the molded graphite article is moved up and down in a mold cavity during the subsequent hot pressing under press load.

16. A method according to claim 15, characterized in that the molded graphite article is ejected at a temperature at which the binder resin solidifies and at which the lubricant stearic acid is still liquid.

17. A method according to claim 15, characterized in that the molded graphite article is coked in a recirculating gas furnace.

18. A method according to claim 17, characterized in that the secondary coke formed during coking of the binder resin is converted into silicon carbide or zirconium carbide or both in vacuum at temperatures of lower than 2000° C.

19. Reflector graphite according to claim 2, characterized in that the proportion of silicon carbide is in a range of 6 to 14% by weight and the content of zirconium carbide is 10 to 30% by weight.

20. Reflector graphite according to claim 19, characterized in that the content of silicon carbide is in a range of 6 to 14% by weight, and the content of zirconium carbide is 20 to 25% by weight.
